(19) United States
(12) Patent Application Publication
(10) Pub. No.: US 2017/0100844 A1
(43) Pub. Date: Apr. 13, 2017

(54) ROBOT ARM AND ASSEMBLY SET

(71) Applicant: igus GmbH, Koln (DE)

(72) Inventors: Martin RAAK, Koln (DE); Felix BERGER, Koln (DE)

(21) Appl. No.: 15/128,665

(22) PCT Filed: Mar. 23, 2015
(86) PCT No.: PCT/EP2015/056046

§ 371 Date: Sep. 23, 2016

(30) Foreign Application Priority Data
Mar. 24, 2014 (DE) 20 2014 101 342.3

(51) Int. Cl. B25J 17/00; B25J 9/08; B25J 9/12; B25J 9/10

(52) U.S. Cl. CPC B25J 17/00; B25J 9/102; B25J 9/08; B25J 9/12; Y10S 901/19; Y10S 901/28

(57) ABSTRACT

The invention relates to a robot arm (1) having a modular structure and directly driven arm joints (2). To simplify and facilitate assembly of the robot arm (1), it is proposed that the arm joints (2) each display a drive module (3) having a directly driven worm drive (31) for generating a torque effective in relation to an axis of rotation (a, a1, a2, a3, a4, a5) of the drive module (3), and a connecting module (4), following on axially from the drive module (3) in relation to the axis of rotation (a), for transmitting the torque to an arm joint (2) located downstream in relation to a drive sequence, in the direction of a head-side end joint (21) of the robot arm (1). The invention further relates to a kit (8) for the robot arm (1).

The invention relates to a robot arm having a modular structure and directly driven arm joints. The invention further relates to a kit for the robot arm.

A generic robot arm is described in DE8310067U1, where the drive is located in a tubular first rotating part that is connected in non-rotating fashion to an upstream robot element and the output side is connected in torque-transmitting fashion to a second tubular rotating part arranged coaxially to the first rotating part. A robot arm of this kind displays an elaborate, relatively inflexible structure that is not easy to assemble.

One object of the invention is to further develop the generic robot arm in such a way that it displays a simpler structure and is easier to assemble.

According to the invention, the object is solved by the characteristics of Claim 1. Advantageous developments are described in the sub-claims. The object is already solved in that the arm joints each display a drive module having a directly driven worm drive for generating a torque effective in relation to an axis of rotation of the drive module, and a connecting module, following on axially from the drive module in relation to the axis of rotation, for transmitting the torque to an arm joint located downstream in relation to a drive sequence, in the direction of a head-side end joint of the robot arm.

It is proposed that the connecting module be located between two drive modules in torque-transmitting fashion. In relation to the output sequence, the connecting module follows on from the drive module of the associated arm joint in axial fashion. The modules of the arm joint are arranged in an axial row. A particularly simple, clearly arranged modular structure is thus proposed, where one module connects axially, and preferably directly, to the downstream module. The robot arm is preferably constructed from a series of modules strung together up to the envisaged working head. The working head can be attached to a head-side end joint. The robot arm can display a base end joint that is mounted in bearings or fixed on a base. The robot arm, including the end joints, can be constructed entirely from a series of modules strung together.

Because of its clear layout, this consistent stringing together of the modules also has the advantage that the risk of assembly errors can be largely reduced, meaning that it is possible for even less-experienced fitters to assemble and fit the robot arm correctly. The axial stringing together of the modules moreover permits a compact design of the robot arm. The drive module, in particular, can be provided with a symbol, a marking and/or a colour to indicate the drive sequence. In addition, this stringing together of the modules of the robot arm in relation to the respectively associated axis of rotation permits structurally simple variations that are explained below as examples. The arm joints can thus be designed as rotary joints.

To further simplify the modular structure of the robot arm, it is proposed that the drive modules and/or the connecting modules of the robot arm each be of identical design. This identicalness of design can also apply to each of the modules mentioned below.

The drive module itself can likewise display a very simple structure. To this end, the worm drive can comprise a drive motor and a worm, driven by means of the drive motor, that is connected to a worm wheel in torque-transmitting fashion, where the worm wheel is advantageously mounted in a radial/axial sliding bearing in a manner permitting movement about the axis of rotation.

In a development of the robot arm, provision can be made for a certain angle, at which the axes of rotation of two drive modules connected via the connecting module are set, to be defined by means of the connecting module. Similarly, a certain distance to the axes of rotation can be defined via the connecting module. This means that a desired distance and/or angle can be achieved via the dimensioning of the connecting module. The connecting module can be designed as an angle piece with two legs, where the angle can be set via the inclination of the legs relative to each other.

The connecting module and/or the drive module can each display a first connecting surface on the input side and a second connecting surface on the output side for connection to the respectively adjacent module. The first connecting surface of the connecting module, located on the input side, can be fixed on a second connecting surface, provided on the output side of the drive module. This makes it possible to vary the orientation of the connecting module in relation to the drive module in a simple manner via the rotational position of the two connecting surfaces relative to each other.

This is particularly advantageous if the connecting module is designed as an angle piece. As a result, the surface normals of the connecting surfaces of the connecting module can be positioned at an angle to each other. If, as described as an example below, there are two connecting modules between two drive modules, the orientation of the two drive modules relative to each other, and thus of the drive module provided on the output side and its axis of rotation, can be decisively changed via the relative position of the two connecting modules.

In a development of the robot arm, provision can be made for the angle and/or the distance to be adjustable. The angle can be less than or equal to 180°, preferably less than or equal to 120°, or particularly less than or equal to 90°.

In a preferred arrangement of the modules of the robot arm, provision can be made for the connecting module of at least one arm joint of the robot arm to be connected to the worm wheel of a driving drive module on the input side, and to the housing of the drive module of the downstream arm joint on the output side. In this context, the connecting module can be connected to the housing and/or the worm wheel by flange mounting.

In another embodiment of the robot arm, provision can be made for two connecting modules, located one behind the other in the output sequence, to be provided at least between two adjacent drive modules of the robot arm, these being directly connected to each other in non-rotating fashion or indirectly connected to each other in non-rotating fashion via an extension module. The distance between two adjacent drive modules can be increased via the extension module. Moreover, the relative rotational orientation of the two connecting modules can be used to set the relative position of the axes of rotation of the drive modules between which the connecting modules are located. It is preferable for the two connecting modules located one behind the other in terms of mechanical rotation to be connected to each other by flanges.

To further simplify assembly, provision can be made that at least some connecting modules and/or at least some extension modules can, as regards their connecting surfaces, be installed in any desired orientation relative to the respective neighbour. If it is envisaged that the size of the modules is to change towards the end element of the robot arm, particularly to become smaller from a first size to a second size, provision is preferably made for this change in size to take place in the connecting module. To this end, the connecting module can display the first size on its first connecting surface, on the input side, and the second size on its second connecting surface, on the output side.

In a development of the robot arm, provision can further be made for an extension module to be located on at least one arm joint of the robot arm, on the input side and/or on the output side in relation to the connecting module. This permits further variations in the design of the arm joints of the robot arm in terms of the relative position of the axes of rotation of the affected drive modules.

In an advantageous embodiment of the robot arm, the extension module can be a profile section, particularly a tubular profile section. This has the advantage that the profile section or tubular profile section can even be cut off to a certain length on-site from a from a profile bar.

For advantageous simplicity, both ends of the profile section can preferably be connected to the respectively associated connecting modules, or to the associated connecting module and drive module, in non-rotating fashion by means of a plug-in/clamping connection provided.

In an alternative solution to the object defined at the beginning, provision can be made for the robot arm to display at least one module, particularly an extension module, the output-side end of which is provided with at least two connecting points. In this way, the robot arm can be split into two secondary arms at this point, e.g. in order to be able to act on the workpiece to be processed from two sides at the ends of the secondary arms. In this context, the at least two connecting points can optionally be designed for one module to be connected, or each for one module to be connected, particularly a connecting module, extension module or drive module. It is also advantageous, in terms of a greater range of variations of the robot arm, if provision is made for the at least two connecting points to be located at a different angle relative to the pivoting axis of the drive module driving the module displaying the at least two connecting points. Preferably, at least one of the angles is adjustable. The at least two connecting points can be designed for identical or different sizes. They can be designed for connecting identical or different modules. If at least two connecting points are provided on the output side of a drive module, an intermediate gearbox can be provided on the output side of the drive module, by means of which the torque generated by the drive module can optionally be transmitted to one of the modules attached to the connecting point, or to both attached modules.

Advantageously as regards an expanded range of motion of the robot arm and a possible reduction of the mass of the robot arm to be moved, provision can be made for the sizes of the installed drive modules and/or of the installed connecting modules to decrease in the direction towards the head-side end of the robot arm.

As an alternative for solving the object, a kit for assembling a robot arm according to one of the embodiments described above and below can be provided, where the kit comprises drive modules and connecting modules. This kit can be kept in stock and used on-site for assembly of the robot arm. Provision can be made for the kit to display a certain number of identically designed drive modules and/or identically designed connecting modules.

To facilitate assembly, provision can be made for at least some of the drive modules and/or at least some of the connecting modules in the kit to be of different sizes.

In addition, the kit can advantageously also include extension modules. At least some of the extension modules provided in the kit can be of different sizes. The extension modules can be designed as profile sections, particularly as tubular profile sections. The kit can also include profile bars of a certain length and/or several certain lengths and/or cross-section sizes. In this context, the profile bars can each display an identical profile cross-section. As a result, the profile bars can be cut off to the length required in each case on-site.

The profile bars or tubular sections can in each case be made of a metallic material, particularly aluminium. The connecting modules can likewise be made of metal, but preferably of plastic. The connecting modules can be made of plastic by means of injection moulding, or preferably by laser sintering.

The present invention is described in more detail below on the basis of an embodiment of the robot arm illustrated in a drawing. The Figures show the following:

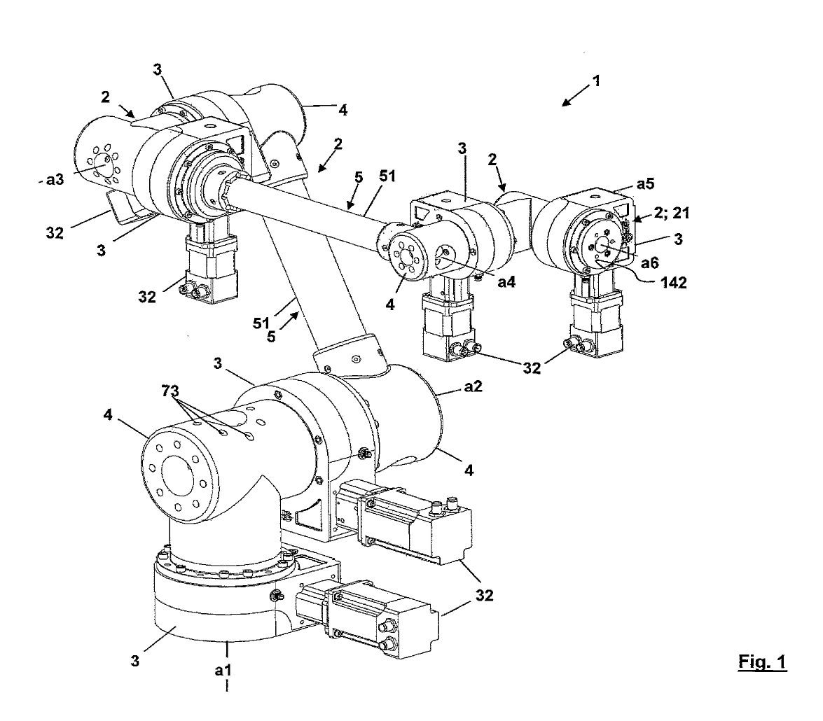

FIG. 1 A perspective view of a robot arm with different arm joints, constructed from modules,

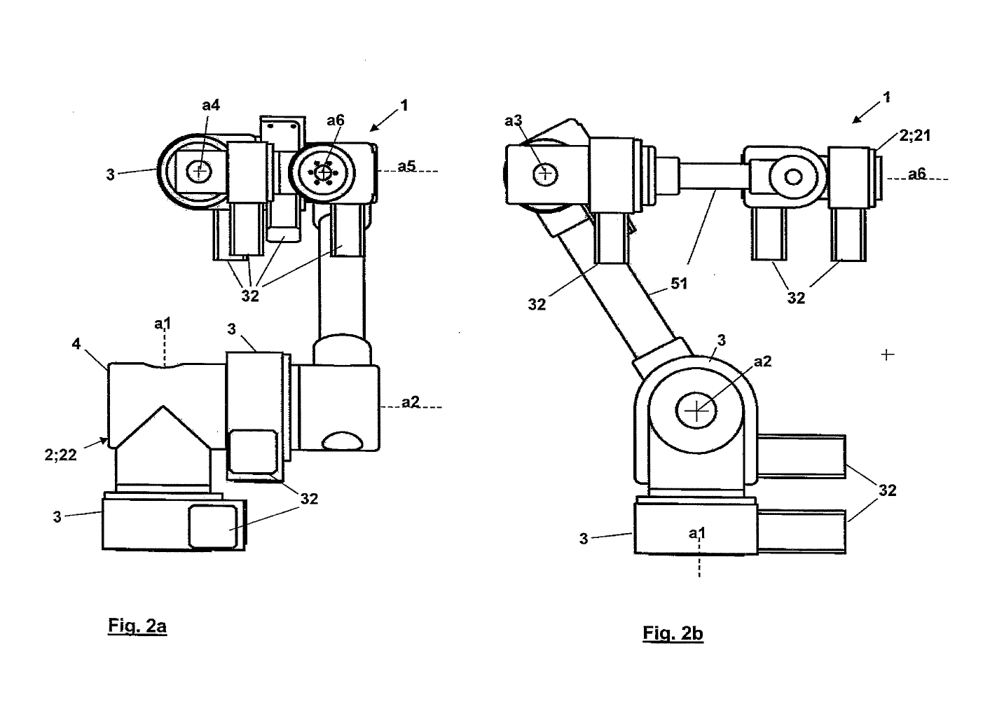

FIGS. 2a and 2b A side view of the robot arm according to FIG. 1,

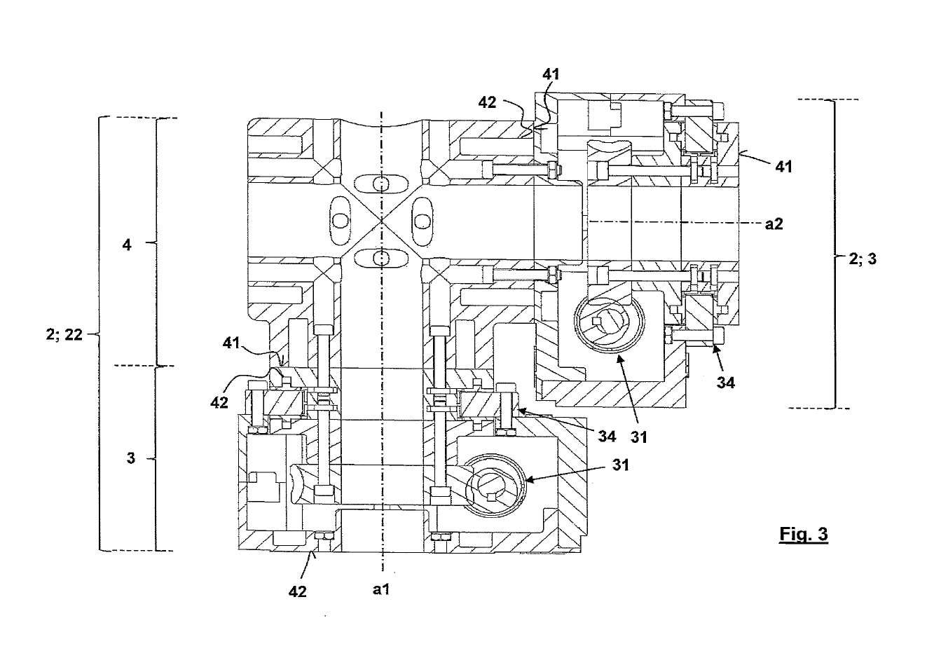

FIG. 3 A longitudinal section of a first embodiment of the arm joint, with a drive module connected,

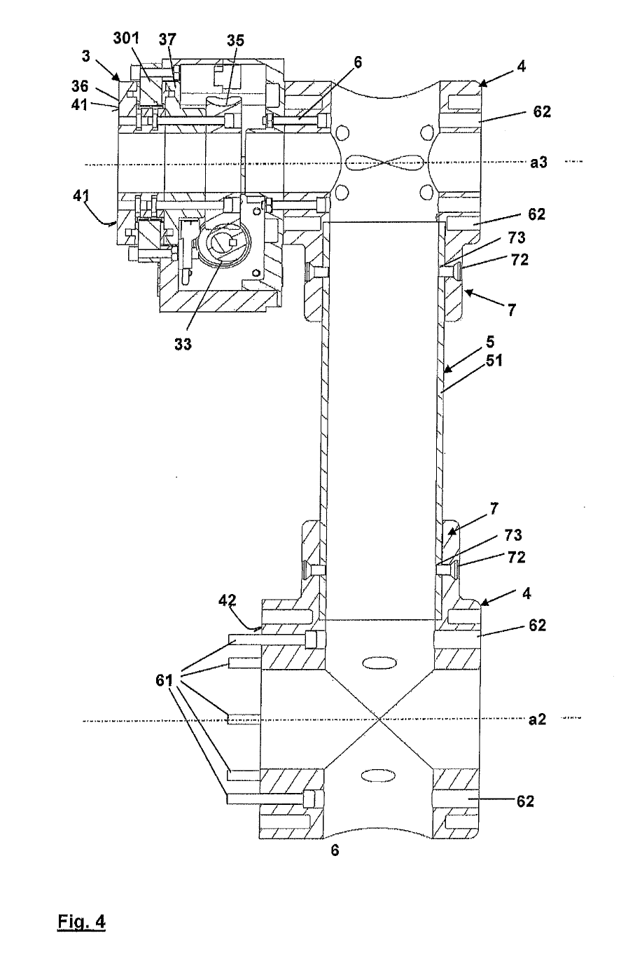

FIG. 4 A longitudinal section of a second embodiment of the arm joint,

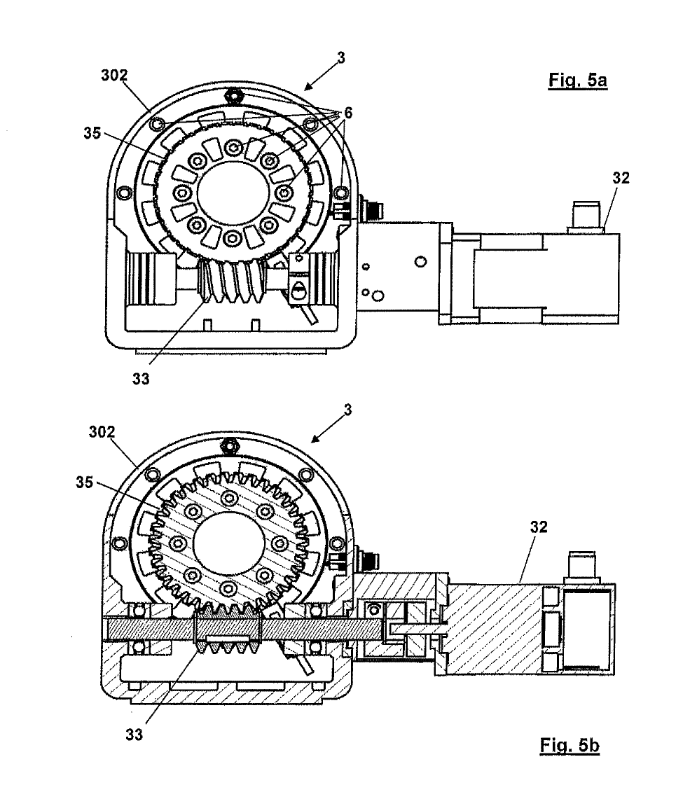

FIGS. 5a and 5b A side view of the drive module with open housing and a cross-section of the drive module according to FIG. 5a,

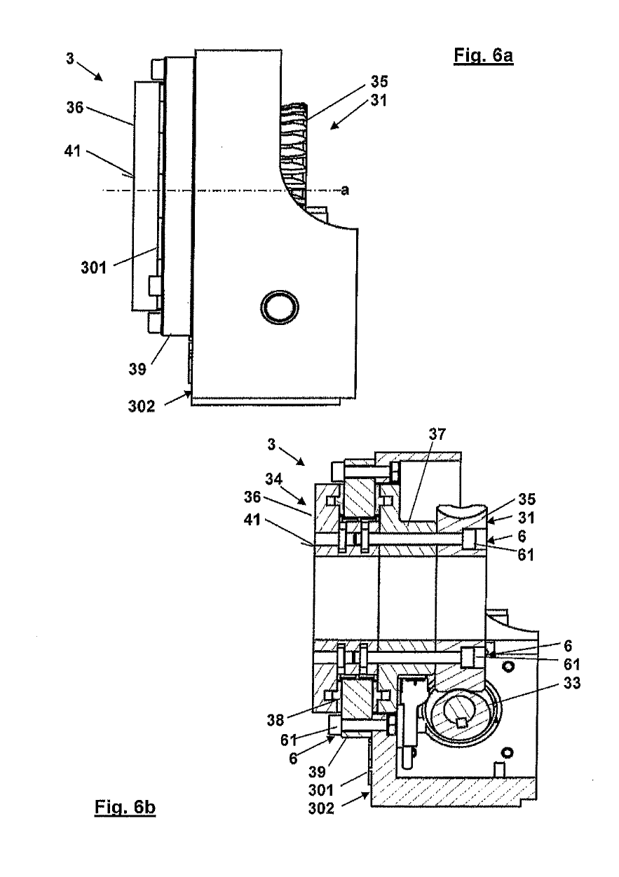

FIGS. 6a and 6b A further side view of the drive module according to FIG. 5a and a longitudinal section of the drive module according to FIG. 6a,

FIGS. 7 to 10 A longitudinal section of an embodiment of a connecting module of the robot arm,

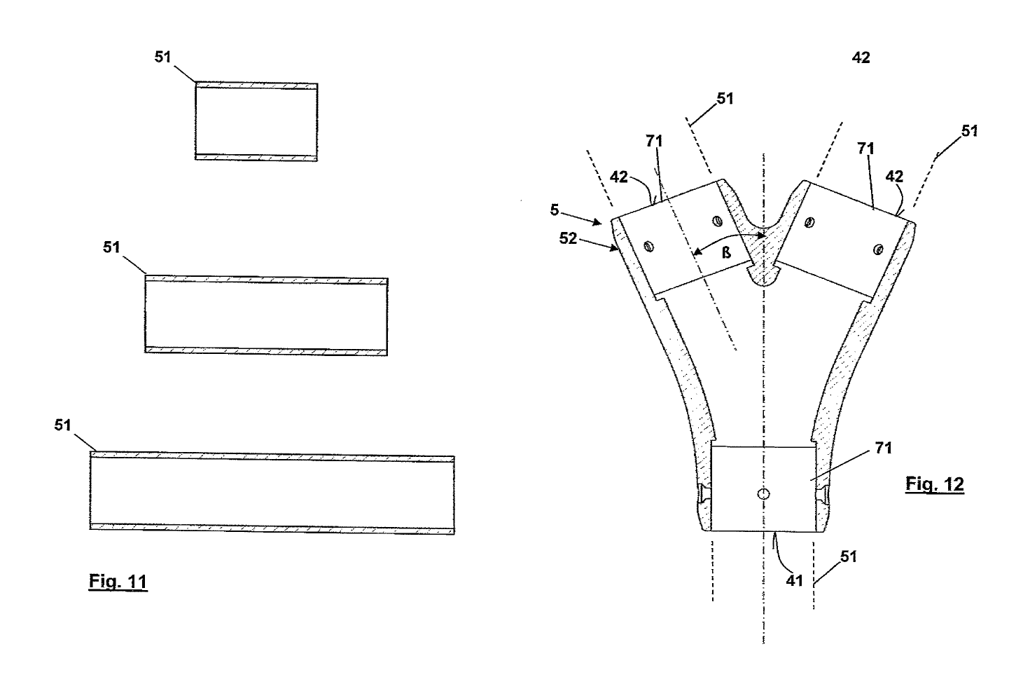

FIG. 11 Three cross-sections of a tubular profile section as an example of an extension module,

FIG. 12 A longitudinal section of a further embodiment of the extension module, with double end connection, and

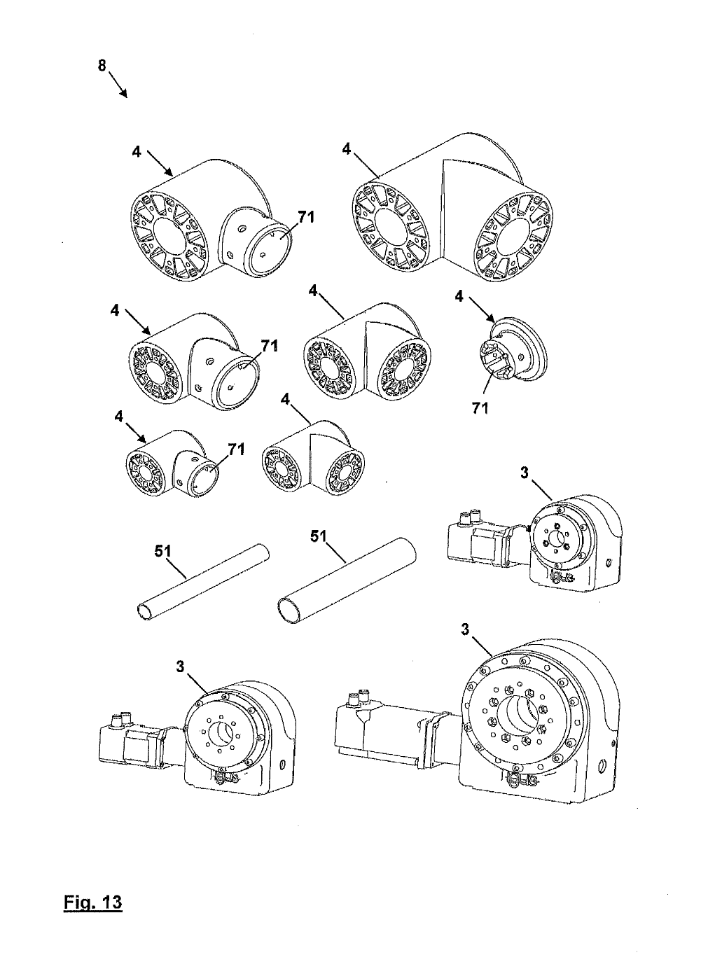

FIG. 13 A kit for a robot arm, with perspective individual views of modules, some in different sizes.

FIGS. 1 and 2 show different views of a robot arm 1 having a modular structure and directly driven arm joints 2. Arm joints 2 each display a drive module 3 with a directly driven worm drive 4 for generating a torque effective in relation to an axis of rotation a of drive module 3. Further provided is a connecting module 5, following on from drive module 3 axially in relation to axis of rotation a, for transmitting the torque to an arm joint 2 located downstream in relation to a drive sequence, in the direction of a head-side end joint 21 of robot arm 1. Connecting module 5 is thus located between two drive modules 3 in torque-transmitting fashion. In this case, robot arm 1 is constructed entirely from modules, including drive modules 3 and connecting modules 5. FIGS. 1 and 2 only show the drive module 3 of end joint 21 since, for example, a working head could be fitted on the output side of drive module 3, thus acting as a kind of positioning module. It can also be deduced from FIGS. 1 and 2 that the modular design of arm joints 2 could be continued from end joint 21, and that the invention is thus not limited to the number of arm joints shown in FIGS. 1 and 2.

FIG. 3 shows a longitudinal section of an embodiment of arm joint 2, where said arm joint 2 is at the same time the base joint 22 of the robot arm 1 shown in FIG. 1. Base joint 22 has the basic form of an arm joint 2 with drive module 3 and downstream connecting module 4. FIG. 4 further shows a longitudinal section of connecting module 4 of arm joint 2, following on from base joint 22, and drive module 3 of arm joint 2, following on from it.

As can be seen from FIG. 3, the form of connecting module 4 of base joint 22 is angled at a right angle. A longitudinal section of this embodiment of connecting module 4 is further shown in FIG. 7. The consequence of this angled form of connecting module 4 is that the axes of rotation a1, a2 of the drive modules 3 connected via connecting module 4 are positioned at an angle β of 90° in this instance. Connecting module 4 displays a first connecting surface 41 on the input side and a second connecting surface 42 on the output side. In this context, the two surface normals of connecting surfaces 41, 42 are arranged at the angle β of 90° in this instance. It can be seen directly from the drawing that angle β can be changed, e.g. by positioning connecting surfaces 41, 42 at an angle to axis of rotation a. The same applies to the remaining modules 3, 5, as shown as an example in FIG. 12 further below on the basis of a further embodiment of extension module 5. In this case, the angle β between the surface normals of the connecting surfaces is 30°.

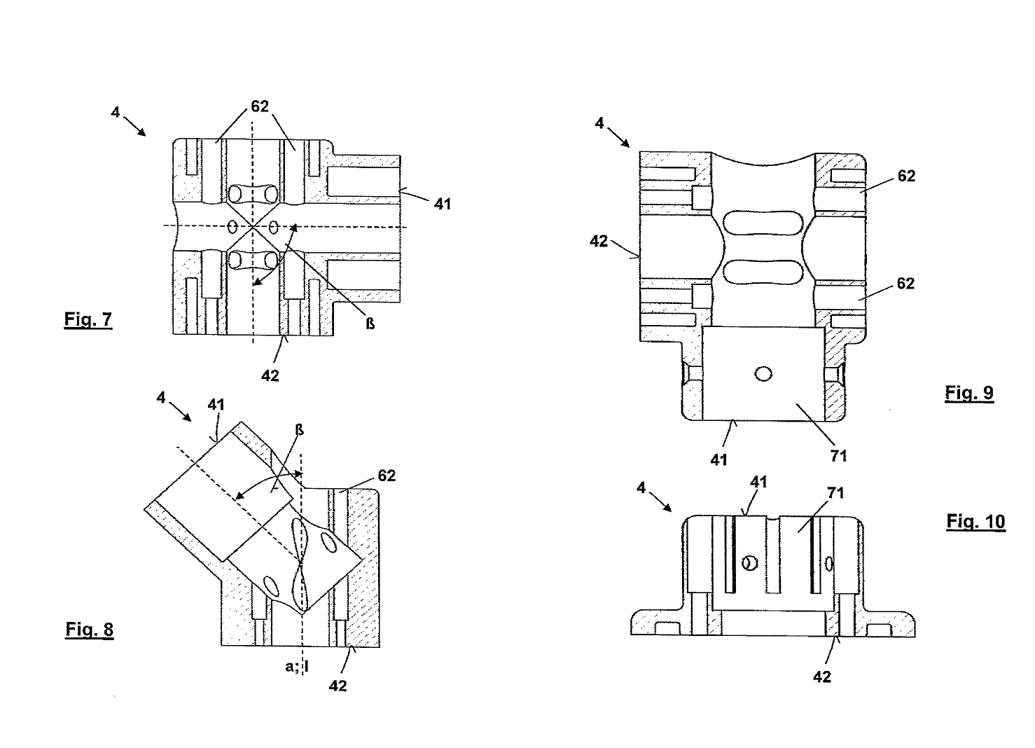

Clearly visible in FIG. 4 is a ring of screws 61, projecting from second connecting surface 42 of bottom connecting module 4, for screw connection 6 to the drive element. Downstream of its drive module (not shown here) in the output sequence, arm joint 2 displays a right-angled connecting module 4, the principle of which is shown in the longitudinal section of connecting module 4 in FIG. 9. Provided downstream of this connecting module 4 is an extension module 5, in the form of a tubular profile section 51 with circular cross-section in this instance, via which a gap can be created between drive modules 3. An example of this tubular profile section 51 is also illustrated in FIG. 11, where three tubular profile sections 51 of different length are shown. Although not specifically shown here, this tubular profile section 51 can be cut to length from a corresponding profile bar, for example. Provided downstream of extension module 5 in the output sequence is a further right-angled connecting module 4, which has the same design, but a smaller size than preceding connecting module 4. As can be seen directly from FIG. 4, the two connecting modules 4 and extension module 5 create the situation that axes of rotation a2, a3, assigned to arm joints 2, are arranged parallel at a distance from each other. This distance can be set via the length of tubular profile section 51.

The reference numbers of axis of rotation a of robot arm 1 are given indices in accordance with their output sequence, where base element 22 has axis of rotation a1, downstream arm joint 2 has axis of rotation a2 and so on, up to end joint 21, which has axis of rotation a6. Entered accordingly in FIG. 4 are axis of rotation a2 of arm joint 2 following on from base joint 22, and axis of rotation a3 of the arm joint following on from there and not shown in FIG. 4.

Connecting module 4 downstream of drive module 3, or modules 4, 5 downstream of drive module 3, are connected to the associated drive module 3, or to each other, in non-rotating fashion. In this context, connecting module 4 downstream of drive module 3 is flange-mounted on drive module 3 via a screw connection 6, where screws 61 are each accessible via an associated access channel 62 for loosening or tightening. As can particularly be seen in FIGS. 5 and 6, worm drive 31 displays a drive motor 32 and a worm 33, driven by means of drive motor 32. Worm 33 is coupled to a worm wheel 35 that is mounted in a radial/axial sliding bearing 34 in a manner permitting movement about axis of rotation a. The structure of radial/axial sliding bearing 34 can be seen particularly clearly in FIG. 6b. In this context, a connecting ring 36 and a spacer ring 37, located between worm wheel 35 and connecting ring 36, form a seat 38 for a housing ring 39, where the relative rotation of seat 38 on housing ring 39 takes place on the polymeric sliding elements 301 indicated in FIG. 6b. Housing ring 39 is part of a housing 302 that encompasses drive module 3, where connecting ring 36 with output-side, second connecting surface 42 projects beyond housing 302. Parts of housing 302 have been omitted in FIGS. 5 and 6, in order to make worm drive 31 more easily visible. A radial/axial bearing of this kind is particularly characterised by its low-friction, maintenance-free design. This is attributable to, among other things, the favourable material combination of polymer (sliding element) and metal (bearing surface), particularly of polymer and aluminium. In connection with the radial/axial sliding bearing, reference is made in all other respects to the utility model specification from DE 20 2013 101 374 U1, the content of which is herewith included in the content of the present application, particularly as regards the polymeric sliding elements and their arrangement in the radial/axial sliding bearing.

Worm wheel 35, spacer ring 37 and connecting ring 36 are connected to each other in non-rotating fashion by a screw connection 6. Provided in alignment with this screw connection 6, to simplify the design, is the screw connection 6 that connects drive module 3 to downstream connecting module 4 to connect it to drive module 3 in non-rotating fashion. Further, housing ring 39 is likewise flange-mounted on housing 302 by means of a screw connection 6. Similarly, connecting modules 4 are flange-mounted on the respectively associated drive module 3 by means of a screw connection 6, specifically on its output-side, first connecting surface 41.

As can be seen from FIG. 4 and FIG. 9, a plug-in/clamping mount 7 is provided for non-rotating connection of tubular profile section 51 to the respectively associated connecting module 4. To this end, the respectively associated connecting module 4 displays a plug-in seat 71 for tubular profile section 51, where lateral clamping screws 72 are provided and screwed in radially against tubular profile section 51. Alternatively, as shown in FIG. 4, a through-hole 73 for each clamping screw 72 can be provided in tubular profile section 51, through which clamping screw 72 is guided in plug-in/clamping connection 7, as a result of which tubular profile section 51 is retained in plug-in seat 71 in non-rotating and non-sliding fashion.

FIGS. 8 and 10 show further embodiments of connecting module 4. According to FIG. 8, plug-in seat 71 is arranged at an angle β of 45° to the associated axis of rotation a, which is in this case identical to the longitudinal axis l of connecting module 4. According to FIG. 10, plug-in seat 71 extends in the direction of longitudinal axis l. These two embodiments of connecting module 4 are intended to serve as examples illustrating that a host of variations is possible as regards the connecting module and that the invention is not limited to the embodiment of connecting module 4 shown here.

Extension modules 5 are likewise not limited to the embodiments shown here. As an example, FIG. 12 shows a branched section 52 as part of an extension module 5, which in this case displays three plug-in seats 71, each for accommodating a tubular profile section 51. Two upper plug-in seats 71 and one lower plug-in seat 71 are provided in this context, where upper plug-in seats 71 can be used on the output side, and lower plug-in seat 71 on the input side. More than two upper plug-in seats can also be provided. According to the example in FIG. 12, a tubular profile section 51, indicated by broken lines, can be provided on each of upper plug-in seats 71 of branched section 52, such that robot arm 1 can be split into two secondary arms in this way. These can, for example, each lead to an end-side working head, not shown here. Furthermore, they can each be connected via a connecting module, for example. However, it is also possible to connect a drive module and/or a connecting module at the connecting points.

Again turning to FIG. 1, it can be noted that the design of base joint 22, with drive module 3 and downstream connecting module 4, is repeated in the arm joint located upstream of end joint 21, where, however, the size of base joint 22 is greater than that of end joint 21 or of the arm joint 2 located upstream of end joint 21. This clearly illustrates that provision is made for reducing the size of arm joints 2, from base joint 22 towards arm end joint 21.

As an example of a kit 8 for assembling a robot arm 1, FIG. 13 shows a collection of differently designed drive modules 3, connecting modules 4 and extension modules 5, in the form of tubular profile sections 51, that can be included in a kit 8 of this kind. It goes without saying that this collection is merely an example, the kit 8 shown in FIG. 13 containing those embodiments of the modules required to implement the robot arm 1 according to FIG. 1.

### LIST OF REFERENCE NUMBERS

1 Robot arm
2 Arm joint
21 End joint
22 Base joint
3 Drive module
31 Worm drive
32 Drive motor
33 Worm
34 Radial/axial sliding bearing
35 Worm wheel
36 Connecting ring
37 Spacer ring
38 Seat
39 Housing ring
301 Polymeric sliding element
302 Housing
4 Connecting module
41 First connecting surface
42 Second connecting surface
5 Extension module
51 Tubular profile section
52 Branched section
6 Screw connection
61 Screw
62 Access channel
7 Plug-in/clamping connection
71 Plug-in seat
72 Clamping screw
73 Through-hole
8 Kit
a,a1,a2,a3,a4,a5,a6 Axis of rotation
l Longitudinal axis
β Angle

1. Robot arm having a modular structure and directly driven arm joints, characterised in that the arm joints each display a drive module having a directly driven worm drive for generating a torque effective in relation to an axis of rotation of the drive module, and a connecting module, following on axially from the drive module in relation to the axis of rotation, for transmitting the torque to an arm joint located downstream in relation to a drive sequence, in the direction of a head-side end joint of the robot arm.

2. Robot arm according to claim 1, characterised in that the drive modules and/or the connecting modules of the robot arm are each of identical design.

3. Robot arm according to claim 1, characterised in that the worm drive displays a drive motor and a worm, driven by means of the drive motor, that is coupled in torque-transmitting fashion to a worm wheel, mounted in a radial/axial sliding bearing in a manner permitting rotary movement about the axis of rotation.

4. Robot arm according to claim 1, characterised in that a certain angle (β), at which the axes of rotation of two drive modules connected via the connecting module are positioned, and/or a certain distance between the axes of rotation is defined by means of the connecting module.

5. Robot arm according to claim 4, characterised in that the connecting module and/or the drive module each display a first connecting surface on the input side and a second connecting surface on the output side for connection to the respectively adjacent module.

6. Robot arm according to claim 4, characterised in that the angle (β) and/or the distance can be adjusted.

7. Robot arm according to claim 4, characterised in that the angle (β) is less than/equal to 180°, less than/equal to 120°, or particularly less than/equal to 90°.

8. Robot arm according to claim 1, characterised in that the connecting module of at least one arm joint of the robot arm is connected, particularly by flange mounting, to the worm wheel (35) of a driving drive module on the input side, and to the housing of the drive module of the downstream arm joint on the output side.

9. Robot arm according to claim 1, characterised in that two connecting modules, located one behind the other in terms of mechanical rotation, are provided at least between two adjacent drive modules, these being directly connected to each other in non-rotating fashion or indirectly connected to each other in non-rotating fashion via an extension module.

10. Robot arm according to claim 1, characterised in that an extension module is located on at least one arm joint of the robot arm, on the input side and/or on the output side between the drive module and the connecting module.

11. Robot arm according to claim 9, characterised in that the extension module displays a profile section, particularly a tubular profile section, that can be telescoped.

12. Robot arm according to claim 11, characterised in that both ends of the profile section are connected to the respectively associated connecting modules, or to the associated connecting module and drive module, in non-rotating fashion by means of a plug-in/clamping connection provided.

13. Robot arm according to claim 9, characterised in that the output-side end of the extension module displays at least two connecting points, one or each of them for a connecting module, a drive module or an extension module to be connected.

14. Robot arm according to claim 1, characterised in that the sizes of the individual drive modules and/or the individual connecting modules decrease in a direction towards a head-side end joint of the robot arm.

15. Kit for assembling a robot arm according to claim 1, with drive modules and connecting modules, where the kit displays a certain number of particularly identically designed drive modules and particularly identically designed connecting modules.

16. Kit according to claim 15, characterised in that at least some of the drive modules and/or connecting modules are of different sizes.

17. Kit according to claim 15, characterised in that it additionally includes extension modules, at least some of which are of different sizes and that are particularly designed as profile sections, particularly as tubular profile sections.
